(19) United States
(12) Patent Application Publication
(10) Pub. No.: US 2015/0269952 A1
(43) Pub. Date: Sep. 24, 2015

(54) METHOD, AN APPARATUS AND A COMPUTER PROGRAM FOR CREATING AN AUDIO COMPOSITION SIGNAL

(71) Applicant: Nokia Corporation, Espoo (FI)

(72) Inventor: Juha Petteri Ojanperä, NOKIA (FI)

(21) Appl. No.: 14/421,863

(22) PCT Filed: Sep. 26, 2012
(86) PCT No.: PCT/FI2012/050922

§ 371 Date: Feb. 16, 2015

(51) Int. Cl. G10L 19/02; G10L 21/0208; G10L 25/18

(52) U.S. Cl. CPC G10L 19/02; G10L 25/18; G10L 21/0208

(57) ABSTRACT

An approach for determining an audio composition signal is provided, the approach comprising obtaining a plurality of reduced audio signals, each representing a first predetermined frequency band of a respective audio signal, determining, for each of the plurality of audio signals for a signal segment corresponding to a given period of time, a ranking value indicative of the quality of the respective audio signal on basis of the respective reduced audio signal, selecting an audio signal of the plurality of audio signals for determination of a segment of an audio composition signal on basis of the determined ranking values and determining the segment of the audio composition signal on basis of the selected audio signal. Moreover, an approach for supporting determination of the audio composition signal is provided, the approach comprising capturing an audio signal, extracting audio signal components representing a first predetermined frequency band from the audio signal to form a reduced audio signal, providing the reduced audio signal for a second apparatus for further processing therein, and providing, in response to a request from the second apparatus, a complementary audio signal representing a second predetermined frequency band of the audio signal, wherein the second predetermined frequency band comprises frequency components of the respective audio signal excluded from the first predetermined frequency band.

### TECHNICAL FIELD

The invention relates to a method, to an apparatus and to a computer program for creating an audio composition signal. In particular, the invention relates to a method, an apparatus and a computer program for creating an audio composition signal based on a number of source signals providing a number of temporally overlapping representations of the same audio scene or the same audio source.

### BACKGROUND

FIG. 1 illustrates an arrangement for capturing information content by a plurality of clients 10 that may be arbitrarily positioned in a shared space and thereby capable of capturing information content descriptive of the scene. The information content may comprise, for example, audio only, audio and video, still images or combination of the three. The clients 10 provide the captured information content to a server 30, where the captured information content is processed and rendered to enable provision of respective composition signals to clients 50. The composition signals may leverage the best media segments originating from the plurality of clients 10 in order to provide optimized user experience for the users of the clients 50

The content captured by the clients 10 needs to be translated to composition signal(s) that provide the best end user experience for respective media domain (audio, video). For the audio domain, the target is to obtain high quality audio signal that represents best the audio scene as captured by the plurality of clients 10. Typically, the quality of the captured audio signal originating from a given client may vary depending on the event, depending on the client's position within the event, depending on the noise level in the vicinity of the client, depending on user's actions associated with the client during capturing (e.g. shaking, scratching, or tilting the device hosting the client), and depending on the characteristics of the device hosting the client (e.g., monophonic, stereophonic or multi-channel capture, tolerance to high sound levels, microphone quality, etc). Thus, in order to provide the best possible audio composition signal it is most likely that only a small subset of the clients 10 provide captured audio signals that will in the end contribute to the audio composition signal. This implies that some of the uploaded audio content was wasting transmission bandwidth in the network and storage space in the server 30 as a high number of captured audio signals may end up not being used at all for creation of the audio composition signal.

### SUMMARY

It is therefore an object of the present invention to provide an approach that enables determination of the audio composition signal in a manner that enables efficient use of transmission resources, efficient usage of storage space in the server side and/or reasonable computational complexity in determination of the audio composition signal while still enabling determination of a high quality audio composition signal.

According to a first aspect of the present invention, an apparatus is provided, the apparatus comprising reception portion configured to obtain a plurality of reduced audio signals, each representing a first predetermined frequency band of a respective audio signal, ranking portion configured to determine, for each of the plurality of audio signals for a signal segment corresponding to a given period of time, a ranking value indicative of the quality of the respective audio signal on basis of the respective reduced audio signal, selection portion configured to select an audio signal of the plurality of audio signals for determination of a segment of an audio composition signal on basis of the determined ranking values and signal composition portion to determine the segment of the audio composition signal on basis of the selected audio signal.

Moreover, according to the first aspect of the invention a second apparatus, the second apparatus comprising an audio capture portion configured to capture an audio signal, an audio processing portion configured to extract audio signal components representing a first predetermined frequency band from the audio signal to form a reduced audio signal, and an interface portion configured to provide the reduced audio signal for a second apparatus for further processing therein and to provide, in response to a request from the second apparatus, a complementary audio signal representing a second predetermined frequency band of the audio signal, wherein the second predetermined frequency band comprises frequency components of the respective audio signal excluded from the first predetermined frequency band.

According to a second aspect of the present invention, an apparatus is provided, the apparatus comprising at least one processor and at least one memory including computer program code for one or more programs, the at least one memory and the computer program code configured to, with the at least one processor, cause the apparatus at least to obtain a plurality of reduced audio signals, each representing a first predetermined frequency band of a respective audio signal, to determine, for each of the plurality of audio signals for a signal segment corresponding to a given period of time, a ranking value indicative of the quality of the respective audio signal on basis of the respective reduced audio signal, to select an audio signal of the plurality of audio signals for determination of a segment of an audio composition signal on basis of the determined ranking values and to determine the segment of the audio composition signal on basis of the selected audio signal.

Moreover, according to the second aspect of the invention, a second apparatus is provided, the second apparatus comprising at least one processor and at least one memory including computer program code for one or more programs, the at least one memory and the computer program code configured to, with the at least one processor, cause the apparatus at least to capture an audio signal, to extract audio signal components representing a first predetermined frequency band from the audio signal to form a reduced audio signal, to provide the reduced audio signal for a second apparatus for further processing therein, and to provide, in response to a request from the second apparatus, a complementary audio signal representing a second predetermined frequency band of the audio signal, wherein the second predetermined frequency band comprises frequency components of the respective audio signal excluded from the first predetermined frequency band.

According to a third aspect of the present invention, an apparatus is provided, the apparatus comprising means for obtaining a plurality of reduced audio signals, each representing a first predetermined frequency band of a respective audio signal, means for determining a ranking value indicative of the quality of the respective audio signal on basis of the respective reduced audio signal, configured to determine a ranking value for each of the plurality of audio signals for a signal segment corresponding to a given period of time, means for selecting an audio signal of the plurality of audio signals for determination of a segment of an audio composition signal on basis of the determined ranking values, and means for determining the segment of the audio composition signal on basis of the selected audio signal.

Moreover, according to the third aspect of the invention, a second apparatus is provided, the second apparatus comprising means for capturing an audio signal, means for extracting audio signal components representing a first predetermined frequency band from the audio signal to form a reduced audio signal, means for providing the reduced audio signal for a second apparatus for further processing therein, and means for providing, in response to a request from the second apparatus, a complementary audio signal representing a second predetermined frequency band of the audio signal, wherein the second predetermined frequency band comprises frequency components of the respective audio signal excluded from the first predetermined frequency band.

According to a fourth aspect of the invention, a method is provided, the method comprising obtaining a plurality of reduced audio signals, each representing a first predetermined frequency band of a respective audio signal, determining, for each of the plurality of audio signals for a signal segment corresponding to a given period of time, a ranking value indicative of the quality of the respective audio signal on basis of the respective reduced audio signal, selecting an audio signal of the plurality of audio signals for determination of a segment of an audio composition signal on basis of the determined ranking values and determining the segment of the audio composition signal on basis of the selected audio signal.

According to the fourth aspect of the invention, a second method is provided, the second method comprising capturing an audio signal, extracting audio signal components representing a first predetermined frequency band from the audio signal to form a reduced audio signal, providing the reduced audio signal for a second apparatus for further processing therein, and providing, in response to a request from the second apparatus, a complementary audio signal representing a second predetermined frequency band of the audio signal, wherein the second predetermined frequency band comprises frequency components of the respective audio signal excluded from the first predetermined frequency band.

According to a fifth aspect of the present invention, a computer program is provided, the computer program including one or more sequences of one or more instructions which, when executed by one or more processors, cause an apparatus at least to obtain a plurality of reduced audio signals, each representing a first predetermined frequency band of a respective audio signal, to determine, for each of the plurality of audio signals for a signal segment corresponding to a given period of time, a ranking value indicative of the quality of the respective audio signal on basis of the respective reduced audio signal, to select an audio signal of the plurality of audio signals for determination of a segment of an audio composition signal on basis of the determined ranking values, and to determine the segment of the audio composition signal on basis of the selected audio signal.

According to the fifth aspect of the invention, a second computer program is provided, the computer program including one or more sequences of one or more instructions which, when executed by one or more processors, cause an apparatus at least to capture an audio signal, to extract audio signal components representing a first predetermined frequency band from the audio signal to form a reduced audio signal, to provide the reduced audio signal for a second apparatus for further processing therein, and to provide, in response to a request from the second apparatus, a complementary audio signal representing a second predetermined frequency band of the audio signal, wherein the second predetermined frequency band comprises frequency components of the respective audio signal excluded from the first predetermined frequency band.

The computer program and/or the second computer program may be embodied on a volatile or a non-volatile computer-readable record medium, for example as a computer program product comprising at least one computer readable non-transitory medium having program code stored thereon, the program which when executed by an apparatus cause the apparatus at least to perform the operations described hereinbefore for the respective computer program according to the fifth aspect of the invention.

The exemplifying embodiments of the invention presented in this patent application are not to be interpreted to pose limitations to the applicability of the appended claims. The verb “to comprise” and its derivatives are used in this patent application as an open limitation that does not exclude the existence of also unrecited features. The features described hereinafter are mutually freely combinable unless explicitly stated otherwise.

The novel features which are considered as characteristic of the invention are set forth in particular in the appended claims. The invention itself, however, both as to its construction and its method of operation, together with additional objects and advantages thereof, will be best understood from the following detailed description of specific embodiments when read in connection with the accompanying drawings.

### BRIEF DESCRIPTION OF FIGURES

FIG. 1 schematically illustrates an exemplifying arrangement for capturing information content.

FIG. 2 schematically illustrates an exemplifying arrangement in accordance with an embodiment of the invention.

FIG. 3 schematically illustrates a client in accordance with an embodiment of the invention.

FIG. 4a schematically illustrates division of the frequency components into a first frequency band and a second frequency band in accordance with an embodiment of the invention.

FIG. 4b schematically illustrates division of the frequency components into a first frequency band and a second frequency band in accordance with an embodiment of the invention.

FIG. 5 schematically illustrates a server in accordance with an embodiment of the invention.

FIG. 6 illustrates a method in accordance with an embodiment of the invention.

FIG. 7 illustrates a method in accordance with an embodiment of the invention.

FIG. 8 schematically illustrates an apparatus in accordance with an embodiment of the invention.

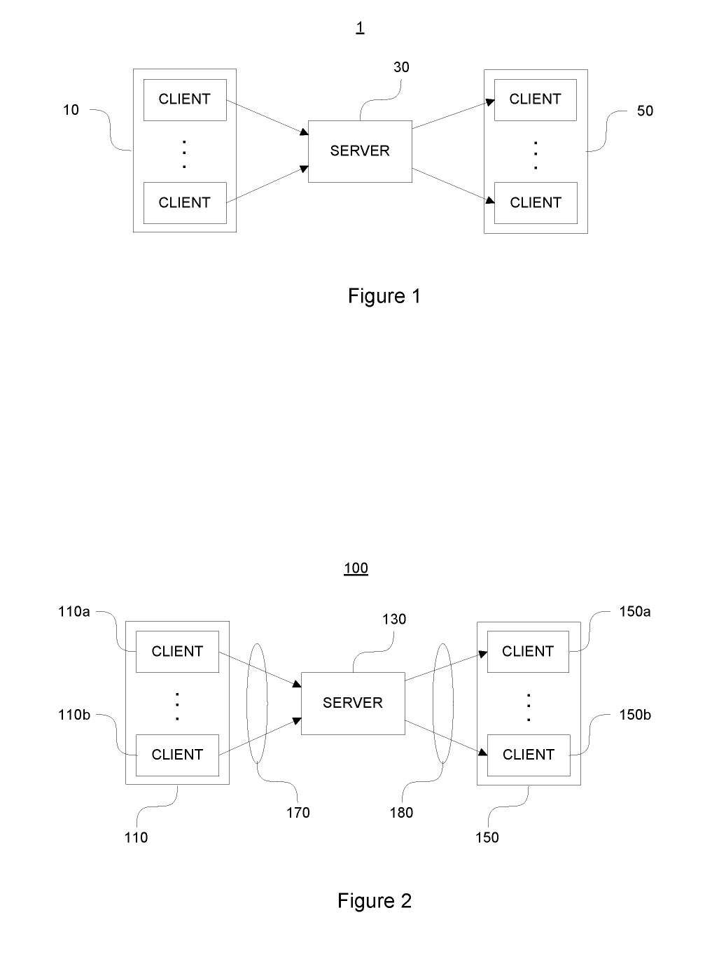

### DETAILED DESCRIPTION

FIG. 2 schematically illustrates an exemplifying arrangement 100 comprising clients 110a, 110b, a server 130 and clients 150a and 150b. The clients 110a, 110b may be connected to the server 130 via a network 170 and may hence communicate with the server 130 over the network 170. Similarly, the clients 150a and 150b may be connected to the server via a network 180 and may hence communicate with the server 130 over the network 180. The networks 170, 180 may be considered as logical entities, and hence although illustrated as separate entities the networks 170 and 180 may represent a single network connecting the clients 110a, 110b, 150a, 150b to the server 130.

The clients 110a, 110b may be configured to operate as capturing clients, whereas the clients 150a, 150b may be configured to operate as consuming clients. Two capturing clients and two consuming clients are illustrated for clarity and brevity of description, but the arrangement 100 may comprise one or more capturing clients 110 and/or one or more consuming clients 150. A capturing client may be configured to capture an audio signal in its environment, and to provide the captured audio signal representing one or more audio sources in its vicinity to the server 130. The server 130 may be configured to receive captured audio signals from a number of capturing clients, the audio signals so received representing the same audio sources, and to create an audio composition signal on basis of the received captured audio signals. A consuming client may be configured to receive the audio composition signal from the server 130 for immediate playback or for storage to enable subsequent playback of the audio composition signal. Although illustrates separately in the arrangement 100, the clients 110a, 110b exemplified as capturing clients may also operate as consuming clients. Similarly, the clients 150a, 150b exemplified as consuming clients may also operate as capturing clients.

The server 130 is illustrated as a single entity for clarity of illustration and description. However, in general the server 130 may be considered as logical entity, embodied as one or more server devices. Each of the networks 170, 180 is illustrated as a single network that is able to connect the respective clients 110a, 110b, 150a, 150b to the server 130. However, the network 170 and/or the network 180 may comprise a number of networks of similar type and/or a number of networks of different type. In particular, the clients 110a, 110b, 150a, 150b may communicate with the server 130 via a wireless network and/or via a wireline network. In case the server 130 is embodied as a number of separate server devices, these server devices typically communicate with each other over a wireline network to enable cost-effective transfer of large amounts of data, although wireless communication between the server devices is also possible.

The communication between the client 110a, 110b, 150a, 150b and the server 130 may comprise transfer of data and/or control information from the client 110a, 110b, 150a, 150b to the server 130, from the server 130 to the client 110a, 110b, 150a, 150b, or in both directions. In case the server 130 is embodied as a number of server devices, the communication between the server devices may comprise transfer of data and/or control information between these devices. The wireless link and/or the wireline link may employ any communication technology and/or communication protocol suitable for transferring data known in the art.

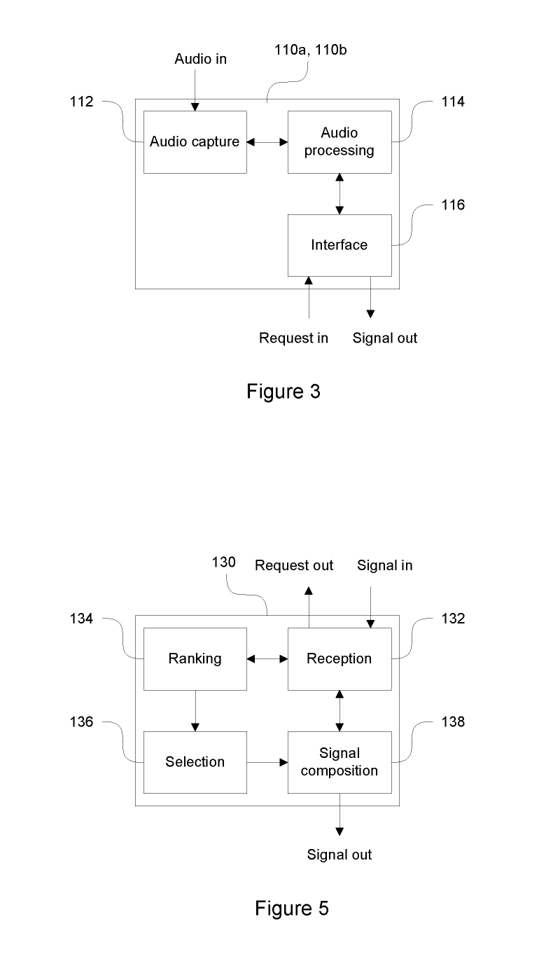

FIG. 3 schematically illustrates a client 110a, 110b of the one or more (capturing) clients 110 in more detail. The client 110a, 110b is configured to capture an audio signal and process it into a reduced audio signal for provision to the server 130 to enable analysis of the characteristics of the captured audio signal in a resource-saving manner. In particular, providing the server 130 with a reduced audio signal instead of the captured audio signal contributes to savings in transmission bandwidth as well as to savings in storage and processing capacity of the server 130.

The client 110a, 110b may be considered as a logical entity, which may be embodied as a client apparatus or an apparatus hosted by the client apparatus. In particular, the client apparatus may comprise a portion, a unit or a sub-unit embodying the client 110a, 110b as software, as hardware, or as a combination of software and hardware.

The client 110a, 100b comprises an audio capture portion 112 for capturing audio signals, an audio processing portion 114 for analysis and processing of audio signals and an interface portion 116 for communication with the server 130 and/or with other entities. As described hereinbefore, the client 110a, 110b may act as a capturing client within the framework provided by the arrangement 100.

The audio capture portion 112 is configured to capture an audio signal. The audio capture portion 112 is hence provided with means for capturing an audio signal or has access to means for capturing an audio signal. The means for capturing an audio signal may comprise one or more microphones, one or more microphone arrays, etc. The captured signal may provide e.g. monophonic audio as a single-channel audio signal, stereophonic audio as a two-channel audio signal or spatial audio as a multi-channel audio signal. The audio capture portion 112 may be configured to pass the captured audio signal to the audio processing portion 114. Alternatively or additionally, the audio capture portion 112 may be configured to store the captured audio signal in a memory accessible by the audio capture portion 112 and by the audio processing portion 114 to enable subsequent access to the stored audio signal by the audio processing portion 114.

The audio processing portion 114 is configured to obtain the captured audio signal, e.g. by receiving the captured audio signal from the audio capture portion 112 or by reading it from a memory, as described hereinbefore. The audio processing portion 114 is configured to determine and/or create a reduced audio signal on basis of the captured audio signal.

The audio processing portion 114 may be configured to process the captured audio signal in frames of predetermined temporal length, i.e. in frames of predetermined duration. As an example, frame durations in the range from a few tens of milliseconds to several tens of seconds, depending e.g. on the available processing capacity and latency requirements, may be employed.

In particular, the audio processing portion 114 is configured to extract audio signal components representing a predetermined frequency band from the captured audio signal. This predetermined frequency band may be also referred to in the following as the first band, as the first frequency band or as the first predetermined frequency band. The audio processing portion 114 may be further configured to form the reduced audio signal on basis of these extracted audio signal components e.g. as a reduced audio signal comprising the audio signal components representing the first frequency band. In particular, the audio processing portion 114 may be configured to form a reduced audio signal that consists of the audio signal components (or frequency components) representing the first frequency band. Providing the server 130 with the reduced audio signal comprising only the frequency components representing the first frequency band contributes to decreased processing power requirement in the server 130 due to smaller amount of information to be processed and to lower bandwidth requirement in a communication link between the client 110a, 110b and the server 130 due to smaller amount of information to be transferred therebetween.

In case of a monophonic audio signal the extracted audio signal components comprise a set of audio signal components representing the first frequency band of the sole channel of the captured audio signal. Consequently, the reduced audio signal comprises a single set of audio signal components representing the first frequency band of the single channel of captured audio signal.

In case of a stereophonic or a multi-channel audio signal a set of audio signal components may be extracted separately for one or more channels of the captured audio signal. In such a scenario the extracted audio signal components may comprise one or more sets of audio signal components representing the first frequency band, each set providing the audio signal components representing the first frequency band for a given channel of the captured audio signal. As an example, a set of audio signal components may be provided for a single channel only, e.g. for a predetermined channel of the captured audio signal or the channel of the captured audio signal exhibiting the highest signal power level among the channels of the captured audio signal. As another example, a dedicated set of audio signal components may be provided for each channel of the captured audio signal. Consequently, the reduced audio signal comprises one or more sets of audio signal components, each set representing the first frequency band of a channel of the captured audio signal. While providing multiple sets of audio signal components may imply increase a minor in transmission bandwidth required to provide the reduced audio signal to server 130 and a minor increase in storage space required in the server 130 for storing the reduced audio signal, at the same it enables more versatile processing and analysis of characteristics of the captured audio signal on basis of the reduced audio signal at the server 130.

In order to enable extracting the audio signal components representing the first frequency band, the audio processing portion 114 may comprise or have access to means for dividing the captured audio signal into two or more frequency bands, one of the two or more frequency bands being the first frequency band. As a particular example, the frequency band may be divided into exactly two bands, i.e. the first frequency band and a second frequency band. However, alternatively, the division may result in third, fourth and/or further frequency bands, resulting in the second frequency band representing only a subset of the frequency components excluded from the first frequency band. The following description assumes division into the first and second frequency bands for brevity and clarity of description, but the description generalizes into an arrangement where the second frequency band covers only a subset of frequency components excluded from the first band and hence suggesting that there may be one or more further frequency bands representing frequency components excluded from the first and second frequency bands.

As an example, the means for dividing the captured audio signal into two or more frequency bands may comprise an analysis filter bank configured to divide the captured audio signal or one or more channels thereof into the first frequency band signal into two subband signals, i.e. into a first subband signal representing the first frequency band and into a second subband signal representing the second frequency band. Consequently, the first subband signal may be used as the basis of the reduced audio signal. Depending on the type of the employed filterbank, the first and second subband signals may be time-domain signals or frequency-domain signals.

As a variation of the first example, coding may be applied to the first and/or second subband signals to provide respective encoded subband signals in order to enable efficient usage of transmission bandwidth and/or storage space.

As a second example, the means for dividing the captured audio signal into two or more frequency bands may comprise a time-to-frequency domain transform portion configured to transform the captured audio signal or one or more channels thereof into frequency domain signal comprising a plurality of frequency-domain coefficients. The time-to-frequency domain transform portion may employ for example Modified Discrete Cosine Transform (MDCT) as known in the art. The frequency-domain coefficients may be divided into a first set of frequency-domain coefficients representing the first frequency band and into a second set of frequency-domain coefficients representing the second frequency band. Consequently, the first set of frequency-domain coefficients may be used as the basis of the reduced audio signal.

As a variation of the second example, coding may be applied to the plurality of frequency-domain coefficients to provide a plurality of coded frequency-domain coefficients in order to enable efficient usage of transmission bandwidth and/or storage space. Consequently the coded frequency-domain coefficients may be divided into a first set of coded frequency-domain coefficients representing the first frequency band and into a second set of coded frequency-domain coefficients representing the second frequency band. Any applicable audio coding known in the art may be employed, for example Moving Pictures Experts Group (MPEG) MPEG-1 or MPEG-2 Audio Layer III coding known as MP3, MPEG-2 or MPEG-4 Advanced Audio Coding (AAC), coding according to the International Telecommunications Union Telecommunication Standardization Sector (ITU-T) Recommendation G.718, Windows Media Audio, etc.

The first and further frequency bands extracted at clients of the one or more (capturing) clients 110 preferably cover the same frequencies of the respective captured audio signals in order to subsequently enable fair comparison on basis of the corresponding reduced audio signals in the server 130 in order to select the most suitable captured audio signal for determination of the audio composition signal, as described in detail hereinafter.

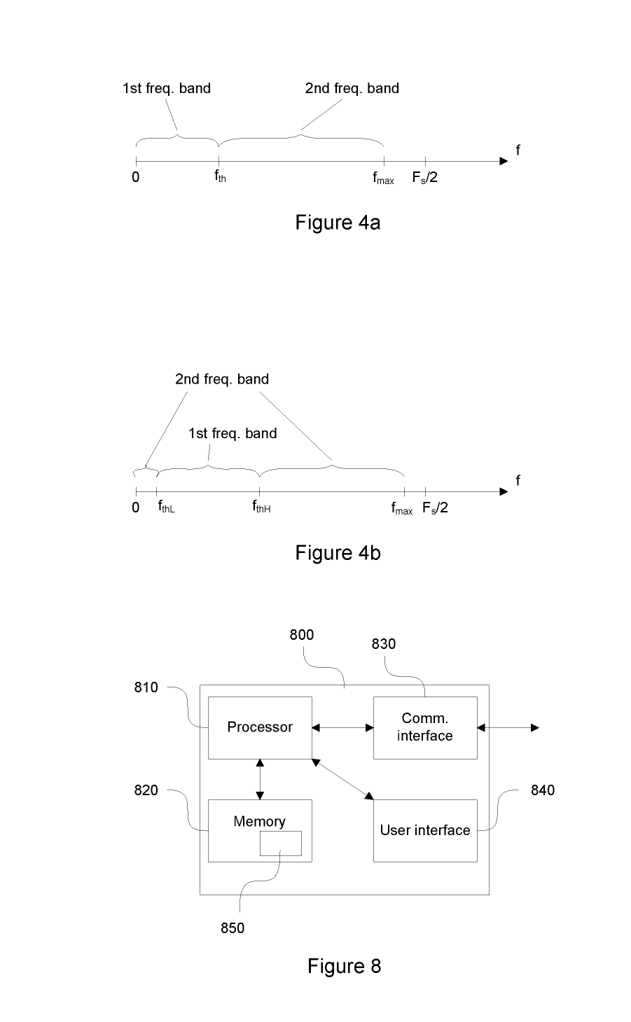

The first frequency band may comprise lowest frequency components up to a threshold frequency fₜₕ, leaving the frequency components from the threshold frequency to a maximum frequency fₘₐₓ to the second frequency band. This is schematically illustrated FIG. 4a. The maximum frequency fₘₐₓ may be the Nyquist frequency Fₛ/2, defined as half of the sampling frequency Fₛ of the captured audio signal. Alternatively, as illustrated in FIG. 3a, the maximum frequency fₘₐₓ may be a frequency smaller than the Nyquist frequency Fₛ/2, resulting in exclusion of some of the highest frequency components from the second frequency band. As a non-limiting example, the threshold frequency fₜₕ may be set to value in the range from 3000 Hz to 12000 Hz, for example to 4000 Hz or to 8000 Hz. The sampling frequency Fₛ is typically 48000 Hz, although different values may be used depending on the application and capabilities of the client 110a. If the maximum frequency fₘₐₓ different from the Nyquist frequency is employed, the maximum frequency may be set, for example, to a value in the range from 18000 Hz to 22000 Hz, e.g. to 20000 Hz.

As a variation of the example on dividing the frequency band into first and second frequency bands, the first frequency band may comprise frequency components from a lower threshold frequency f_{thL} to an upper threshold frequency f_{thH}, thereby leaving the frequency components from 0 to the lower threshold frequency f_{thL} and from the upper threshold frequency f_{thH} to the maximum frequency fₘₐₓ to the second frequency band. Hence, the second frequency band comprises two portions that can be, alternatively, considered as a second frequency band and a third frequency band. This is schematically illustrated in FIG. 4b. As non-limiting exampies, the lower threshold frequency f_{thL} may be set to a value in the range from 50 Hz to 500 Hz, for example to 100 Hz, and the upper threshold frequency f_{thH} may be set to a value in the range from 3000 Hz to 12000 Hz, for example to 4000 Hz or to 8000 Hz.

The audio processing portion 114 may be configured to pass the reduced audio signal to the interface portion 116. Alternatively or additionally, the audio processing portion 114 may be configured to store the reduced audio signal in a memory accessible by the audio processing portion 114 and by the interface portion 116 to enable subsequent access to the stored reduced audio signal by the interface portion 116.

The interface portion 116 is configured to provide the reduced audio signal for the server 130 for further analysis and processing. In particular, the interface portion may be configured to further provide the reduced audio signal to the server 130 as the reduced audio signal is provided by the audio processing portion 114 frame by frame without an explicit request to one or more specific fames, e.g. by streaming the captured audio signal to the server 130 in a sequence of frames or in a sequence of packets, each packet carrying one or more frames. Alternatively, the interface portion 116 may be configured to provide reduced audio signal to the server 130 in response to a request from the server 130. Such a request may, for example, request one or more next frames in sequence of reduced audio signal to be provided to the server 130, request one or more frames of recued audio signal representing one or more given periods of time to be provided to the sever 130, or request the reduced audio signal in full to be provided to the server 130.

The interface portion 116 may be configured provide further information associated with the captured audio signal in addition to the reduced audio signal. Such further information may comprise, for example, one or more indicators or parameters indicative of the channel configuration of the captured audio signal, of the channel configuration of the reduced audio signal and/or of the relationship between the channel configuration of the captured audio signal and that of the reduced audio signal.

Since the server 130 is configured to determine and/or select the most suitable audio signal among a plurality of audio signals on basis of the corresponding reduced audio signals for determination of an audio composition signal, as described in more detail hereinafter, the interface portion 116 is further configured to provide, in response to a request from the server 130, one or more segments of audio signal comprising one or more audio signal components representing the captured audio signal to enable reconstruction of the captured audio signal at the server 130. Such a signal is referred to in the following as a complementary audio signal.

A segment of complementary audio signal may comprise only audio signal components that were excluded from the respective segment of reduced audio signal. In particular, the complementary audio signal may comprise the audio components representing the second frequency band for one or more channels of the captured audio signal. Consequently, the server 130 is able to reconstruct the audio signal for determination of the audio composition signal as a combination of the complementary audio signal and the respective reduced audio signal. Such an approach avoids re-transmitting the audio signal components of captured audio signal already provided to the server 130 as part of the reduced audio signal, hence enabling more efficient use of transmission resources.

As another example, the approach described in the previous paragraph may be applied for some of the channels of the captured audio signal, whereas the complementary audio signal comprises some of the channels of the captured audio signal in full. This may be required e.g. in an approach where the reduced audio signal was based on a subset of channels of the captured audio signal.

As a further example, the complementary audio signal may comprise the captured audio signal in full for all channels, thereby comprising also the audio signal components representing the first frequency band. While this may result in re-transmitting the audio signal components of representing the first frequency band, at the same time the processing in the server 130 is simplified since there is no need to reconstruct the audio signal on basis of the reduced audio signal and the complementary audio signal.

FIG. 5 schematically illustrates the server 130 in more detail. The server 130 is configured to receive reduced audio signals originating from the one more capturing clients 110 and to determine, for a given period of time, the most suitable audio signal for determination of an audio composition signal on basis of the reduced audio signals originating from the one or more capturing clients 110.

The server 130 may be considered as a logical entity, which may be embodied as a server apparatus or as an apparatus hosted by the server apparatus. In particular, the server apparatus may comprise a portion, a unit or a sub-unit embodying the server 130 as software, as hardware, or as a combination of software and hardware. Instead of a single server apparatus, the server 130 may be embodied by two or more server apparatuses or two or more server apparatuses, each hosting one or more portions of the server 130. In particular, each server apparatus of the two or more server apparatuses may comprise a portion, a unit or a sub-unit embodying one or more portions of the server 130 as software, as hardware, or as a combination of software and hardware.

The server 130, as illustrated in FIG. 5, comprises a reception portion 132 for obtaining reduced audio signals representing respective captured audio signals originating from respective clients of the one or more clients 110, a ranking portion 134 for determining ranking values on basis of the reduced audio signals, a selection portion 136 for selecting one of the plurality of captured audio signals on basis of the determined ranking values and a signal composition portion 138 for determining an audio composition signal on basis of the determined ranking values.

The reception portion 132 is configured to obtain a plurality of reduced audio signals, each reduced audio signal representing the first frequency band of the respective captured audio signal originating from one of the one or more clients 110, e.g. from the client 110a, 110b. The one or more clients 110 are assumed to be positioned in a shared space and, consequently, the captured audio signals originating therefrom can be considered to provide different ‘auditory views’ to one or more audio sources within the shared space. The number of reduced audio signals received at the server 130 may vary over time due to some of the clients entering the shared space, leaving the shared space or initiating or discontinuing provision of reduced audio signal for other reasons. Since the one or more clients 110 are positioned in different orientation and distance with respect to sound sources within the shared space and also may also have means for capturing an audio signal of different characteristics and quality in their disposal, the reduced audio signals originating from the one or more clients 110 typically vary in quality.

As described hereinbefore in context of the client 110a, 110b, the interface portion 116 may be configured to provide the reduced audio signal in frames, either continuously or in response to a request from the server 130. Hence, the server 130, e.g. the reception portion 132, may be configured to request the reduced audio signal to be continuously provided, e.g. streamed, thereto, or the server 130 may be configured to request one or more specific frames of the reduced audio signal from the client 110a, 110b as further frames of reduced audio signal are needed for further processing in the server 130. Such an approach enables ‘live’ processing of the reduced audio signal and, hence, enables making the audio composition signal available for the one or more (consuming) clients 150 at a small latency. As a variation of such ‘live’ processing, the server 130 may be configured to store a predetermined number of frames, or more generally a predetermined duration of reduced audio signal, before processing it further. As a specific further example, the server 130 may be configured to request the captured audio signal in full, thereby providing possibly a long latency until making the audio composition signal available to the one or more (consuming) clients 150 while on the other hand enabling full analysis of the reduced audio signal before further processing, possibly enabling further optimization (in terms of quality) of the audio composition signal.

As described hereinbefore, the reduced audio signal may comprise a set of audio signal components representing the first frequency band of the sole channel of a monophonic captured audio signal or a set of audio signal components representing the first frequency band of one of the channels of a stereophonic or multichannel captured audio signal. Alternatively, the reduced audio signal may comprise multiple sets of audio signal components representing the first frequency band, each set representing the first frequency band of a channel of the captured audio signal. Hence, the reduced audio signal is reduced in that it contains a subset of the frequency components of the captured audio signal, preferably only the audio signal components representing the first frequency band of a channel of the captured audio signal.

In case the reduced audio signal is received in encoded format, the reception portion 132 may be configured to apply corresponding decoding to the received reduced audio signal before further processing of the reduced audio signal in the server 130.

Obtaining the plurality of reduced audio signals may comprise receiving each reduced audio signal of the plurality of the audio signals directly from the respective client of the one or more clients 110. Alternatively, obtaining the plurality of reduced audio signals may comprise receiving all reduced audio signals of the plurality of audio signals from a single entity, for example from an intermediate server entity configured to receive the reduced audio signals from the respective clients and to pass the received reduced audio signals further to the reception portion 132 of the server 130—in other words the intermediate server entity would implement the interface portion 116. As a variation of this alternative, the intermediate server entity may be configured to receive the captured audio signals from the one or more clients 110, to extract audio signal components representing the first frequency band therefrom into respective reduced audio signals and to provide the reduced audio signals to the reception portion 132—in other words the intermediate server entity would implement the audio processing portion 114 and the interface portion 116.

As a further alternative, obtaining the plurality of reduced audio signals may comprise extracting the audio signal components representing the first frequency band from the captured audio signal or from a reconstructed version thereof. Such a scenario may involve the one or more clients 110 to be configured to provide the server 130 with the respective captured audio signals, thereby assigning the extraction of the audio signal components representing the first frequency band to the server 130, e.g. to the reception portion 132. While such an approach may not facilitate savings in transmission bandwidth between the one or more clients 110 and the server 130 and/or reduced storage space requirements in the server 130, it would still serve to reduce the computational complexity of the ranking process applied in the ranking portion 134 described hereinafter due to the reduced signal representing only the first frequency band and hence having information content that is reduced in comparison to the respective captured audio signals.

The ranking portion 134 is configured to determine, for each of the plurality of captured audio signals, a ranking value indicative of the quality of the respective captured audio signal on basis of the corresponding reduced audio signal. The ranking value preferably reflects subjective or perceivable quality of the respective captured audio signal. The ranking value may hence be indicative of extent of perceivable distortions or disturbances identified on basis of the reduced audio signal. As an example, such perceivable distortions may include sub-segments of the reduced audio signal comprising saturated audio signal, indicating that the input signal may have been clipped due to excessive input level. As another example, such perceivable distortions may include sub-segments of the reduced audio signal exhibiting signal power level exceeding that of a (temporally) adjacent sub-segment by more than predetermined amount, thereby potentially indicative of sudden change in signal level that may be perceived as a ‘click’.

The ranking value serves as a relative quality measure that enables ranking the plurality of captured audio signals with respect to each other. Hence, it is sufficient to provide ranking values as comparison values that may be used for comparison of audio signal quality between the audio signals of the plurality of captured audio signals, while the ranking values may also map to reference scale hence providing also a measure of ‘absolute’ quality. Depending on the applied ranking approach, a higher ranking value may imply higher quality of audio signal or a higher ranking value may imply lower quality of audio signal. While in principle any ranking approach fulfilling these characteristics may be employed, two exemplifying ranking approaches are described in more detail hereinafter.

The ranking portion 134 may be configured to determine the ranking values for the plurality of captured audio signals at predetermined intervals and/or in response to an event, for example in response to the number of reduced audio signals available at the server 130 changing e.g. due to a client initiating or discontinuing provision of the reduced audio signal. The ranking values are preferably determined on basis signal segments of predetermined (temporal) length, i.e. on basis frames of predetermined duration. Alternatively, frames of variable duration may be employed as the basis for the ranking values.

Temporally adjacent frames of a reduced audio signal may be non-overlapping or partially overlapping, whereas the frames originating from different reduced audio signals used as basis for determining a single set of ranking values are preferably temporally overlapping, either in full or in major part in order to enable fair comparison between the plurality of reduced audio signals. As an example, frame durations in the range from a few tens of milliseconds to several tens of seconds, depending e.g. on the available processing capacity and latency requirements, may be employed in determination of the ranking values. Hence, the ranking portion 134 may be configured to determine ranking values for a given frame, corresponding to a given period of time, for the plurality of captured audio signals that are available in the server 130 for the given period of time.

A set of ranking values may be considered applicable only for the signal segment, i.e. the frame, based on which the set of ranking values is determined. Alternatively, a set of ranking values may be considered applicable also for one or more signal segments following the signal segment used as basis for determining the set of ranking values, e.g. until determination of the next set of ranking values. This may be advantageous especially in scenarios where a set of ranking values is determined or re-evaluated in response to an event such as a client initiating or discontinuing provision of respective reduced audio signal and hence a new set of ranking values will be made available once an event triggering determination of the new set of ranking values is encountered.

The ranking portion 134 may be configured to time align the plurality of reduced audio signals in order to enable to (conceptually) putting the plurality of reduced audio signals into a common time line, thereby enabling selection of temporally overlapping signal segments from the plurality of reduced audio signals for determination of a set of ranking values. The time aligning may comprise e.g. determination of time differences or time shifts between the plurality of reduced audio signals and maintaining, at the server 130, a data structure comprising information regarding the current time shift between a reference signal and each of the plurality of reduced audio signals. Such a data structure may comprise, for example, a pointer or an indicator indicating the current frame in the reference signal and a corresponding pointer or indicator for each of the plurality of reduced audio signals. The reference signal may be e.g. one of the plurality of reduced audio signals or a dedicated reference signal. As a particular further example, the reference signal may be the audio composition signal to be determined on basis of the plurality of reduced audio signals. Consequently, for each of the plurality of reduced audio signals, a frame of a reduced audio signal, used as a basis for determination of the respective ranking value within a set of ranking values is chosen such that it is temporally aligned with the reference signal—and also temporally aligned with the other reduced audio signals of the plurality of reduced audio signals.

Time alignment of the plurality of reduced audio signals may be based on timing indicators included in the reduced audio signal or provided and received together with the plurality of reduced audio signals. An example of such timing indicator is the timestamp of the Real-time Transport Protocol (RTP) provided in RFC 3550, which enables synchronization of several sources with a common clock. Alternatively, time alignment may be based on timing indicators provided separately from the respective reduced audio signals. As a further example, the ranking portion 134 may be configured to determine the time alignment on basis of the reduced audio signals, e.g. by a performing signal analysis in order to find a time shift that maximizes cross-correlation between a pair of reduced audio signals or between a reduced audio signal and a reference signal.

The selection portion 136 is configured to select one of the plurality of captured audio signals for determination of the audio composition signal on basis of a set of ranking values. Preferably, for a given frame of audio composition signal, the signal composition portion 136 is configured to select the temporally corresponding frame of the captured audio signal having the ranking value indicative of highest quality within the set of ranking values applicable for the given frame. Instead of directly selecting the highest ranking captured audio signal, the signal composition portion 136 may be configured to select any audio signal having a ranking value that is within a predetermined margin of the ranking value of the highest ranking captured audio signal to or to select any audio signal having a ranking value exceeding a predetermined threshold.

The selection portion 136 may be configured apply ‘live’ selection of the captured audio signal such that, as new frames of the plurality of reduced audio signals become available, the selection is made on basis of the currently applicable set of ranking values. Consequently, the selection is made without consideration of the subsequent segments or frames of the plurality of the reduced audio signals. While this approach facilitates minimizing the delay in making the audio composition signal available for the one or more (consuming) clients 150, it may result e.g. in unnecessary switching between the captured audio signals due to neglecting the ranking values applicable for the subsequent frames of the plurality of reduced audio signals.

Alternatively, the selection portion 136 may be configured to apply delayed selection of the captured audio signal such that the selection for determination of a given segment, or frame, of the audio composition signal is made only after a predetermined duration of the plurality of the reduced signal following the given segment is available in the server 130. As a further alternative, the selection portion 136 may be configured to apply offline selection of the captured audio signal such that the selection for determination of a given segment of the audio composition signal is made only after the plurality of reduced audio signals are available at the server 130 in full. Consequently, the selection may consider also segments of the plurality of reduced audio signals following the given frame. While these approaches may result in longer latency in making the audio composition signal available to the one or more (consuming) clients 150, it e.g. enables post-processing of selected frames, hence contributing to avoid unnecessary switching between captured audio signals that may occur e.g. due to short term quality fluctuations and/or temporary connection problems of (capturing) client(s) otherwise providing high-quality captured audio signal(s).

The signal composition portion 138 is configured to determine the audio composition signal on basis of the selected captured audio signal. In particular, the signal composition portion 138 may be configured to determine a segment, or a frame, of the audio composition signal on basis of the corresponding, i.e. temporally aligned, segment or frame of the selected captured audio signal. The audio composition signal may be determined as a combination or concatenation of (temporally) successive frames of audio composition signal.

Determination of a frame of audio composition signal may comprise obtaining a frame of complementary audio signal (temporally) corresponding to a frame of selected captured audio signal and determining the corresponding frame of audio composition signal as a combination of the obtained frame of complementary audio signal and the respective frame of reduced audio signal. In this regard, the signal composition portion 138 may comprise or have access to means for reconstructing the audio signal in order to determine the audio composition signal as a combination of the complementary signal and the respective reduced audio signal.

As described in detail hereinbefore in context of the interface portion 116, the complementary audio signal may be representative of the second frequency band of the captured audio signal and may hence comprise frequency components of the respective captured audio signal that are excluded from the reduced audio signal representing the first frequency band of the respective captured audio signal.

The signal composition portion 138 may be configured request, either directly or e.g. via the reception portion 132, one or more segments of complementary audio signal from the interface portion 116 in accordance with the captured audio signal(s) selected for the respective segment of the audio composition signal. A request for one or more segments of complementary audio signal originating from a given client of the one or more (consuming) clients 110 preferably comprises indications of start and end points of the one or more segments for identifying the requested segments of complementary audio signal. Consequently, the signal composition portion 138 may be further configured to receive the one or more segments of complementary audio signal.

In case the means for dividing the captured audio signal applied in the audio processing portion 114 comprises an analysis filter bank, the means for reconstructing may comprise a corresponding synthesis filter bank, and the signal composition portion 138 may be configured to apply the synthesis filter bank to combine the complementary audio signal and the respective reduced audio signal. As another example, in case the means for dividing the captured audio signal applied in the audio processing portion 114 comprises dividing a plurality of frequency-domain coefficients into a first and second sets of frequency domain coefficients, the means for reconstructing may comprise means for combining the two sets into one and the signal composition portion 138 may be configured to combine the two sets to form the audio composition signal.

In case the ranking portion 134 processes the audio composition signal in frames, the signal composition portion 138 is preferably configured to compose the audio composition signal using a similar frame structure. In case the origin of the captured audio signal changes between two temporally adjacent frames such that for a first frame the audio composition signal is based on the captured audio signal originating from a first client and for a second frame the audio composition signal is based on the captured audio signal originating from a second client, the signal composition portion 138 may be configured to apply cross-fading of signals between the first frame and the second frame. In such a scenario the first and second frames are preferably partially overlapping and the captured audio signal originating from the first client is gradually faded out during the overlapping portion of the two frames whereas the captured audio signal originating from the second client is gradually faded in in order to provide smooth transition between two audio signal sources of possibly different audio characteristics.

The server 130, e.g. the signal composition portion 138, may be configured to store the audio composition signal in a memory of the server 130 or a memory otherwise accessible by the server 130. Alternatively or additionally, the server 130 may be configured provide the audio composition signal to the one or more clients 150 acting as consuming clients. The server 130 may be configured, for example, to provide the audio composition signal in frames of predetermined temporal length, i.e. in frames of predetermined duration. This may involve streaming the audio composition signal to the one or more consuming clients 150. As an example, frame durations in the range from a few tens of milliseconds to several tens of seconds, depending e.g. on the available processing capacity and latency requirements, may be employed. A first frame duration may be employed in provision of the audio composition signal to a first consuming client, whereas a second frame duration different from the first frame duration may be employed in provision of the audio composition signal to a second consuming client. Instead of providing the audio composition signal on frame-by-frame basis, e.g. by streaming, the audio composition signal may be made available to the one or more consuming clients 150 by downloading the audio composition signal in full.

The one or more clients 150 acting as consuming clients may be configured to receive the audio composition signal from the server 130, to process the received audio composition signal, if required, into a format suitable for provision for audio playback and to provide the audio composition signal for audio playback means accessible by the consuming client. The processing of the received audio composition signal may comprise, for example, decoding of the received audio composition signal. Alternatively or additionally, the processing of the received audio composition signal may comprise transforming the received audio composition signal from frequency domain into time-domain by using an inverse MDCT.

The ranking portion 134 may be configured to apply a first exemplifying ranking approach described in the following. The first exemplifying ranking approach may be applied to one or more source signals. The source signals may be for example the reduced audio signals described hereinbefore or derivatives thereof, and the ranking process may be carried out on basis of a number of temporally at least partially overlapping frames originating from a plurality of source signals. As an example, a derivative of a reduced audio signal used as a source signal may be a downmix signal derived on basis of the reduced audio signal, derived for example by summing or averaging two or more channels of the reduced audio signal into the downmix signal.

In the first exemplifying ranking approach, let t represent the time segment of interest with a segment start time of tₛₜₐᵣₜ and end time of t_{end} that has N at least partially overlapping source signals, i.e. signals from N sources that overlap in time at least in part. The initial ranking value for each of the source signals for this segment is set to

rDataₙ(t)=undefined,0≦n<N (1)

Furthermore, for each source signal the time segment of interest form tₛₜₐᵣₜ to t_{end} is divided into a number of analysis frames, where startFrame and endFrame represent the frame indices of the first analysis frame of the time segment of interest and the frame indice of the last frame of the time segment of interest for the respective source signal, respectively. The following signal measures are calculated for each analysis frame of each source signal within the time segment of interest. The segment level analysis may be carried out using short analysis frames having temporal duration, for example, in the range from 20 to 80 milliseconds, e.g. 40 milliseconds to derive quality measures for analysis frames, and each such measure further contributes to the respective segment level measure. It is also possible that the duration of the analysis frame is not the same for all measures; some may use shorter size and some may use larger size frames. The signal measure for source signal n computed according to equation (2).

$${cEnergy}_{n} ( t ) = \frac{{\sum }_{f = startFrame}^{endFrame - 1} {\sum }_{ch = 0}^{{nCh}_{n} - 1} {avgLevel}_{n} ( f , ch )}{( endFrame - startFrame ) \cdot {nCh}_{n}} , \qquad ( 2 )$$

where nChₙ describes the number of channels present in the source signal n. Equation (2) calculates the average signal level cEnergyₙ(t) for the source signal n. The signal level for the frame level analysis avgLevelₙ for the source signal n may be calculated for example as the average absolute sum of the time domain samples within the analysis frame identified by the index value f. This measure is computed for each channel of the source signal.

The average sum of the signal power cPowerₙ(t) for source signal n may be computed according to equation (3) shown in the following.

$${cPower}_{n} ( t ) = \frac{{\sum }_{f = startFrame}^{endFrame - 1} {\sum }_{ch = 0}^{{nCh}_{n} - 1} {sqrtLevel}_{n} ( f , ch )}{( endFrame - startFrame ) \cdot {nCh}_{n}} \qquad ( 3 )$$

The signal power level for the segment level analysis sqrtLevelₙ for source signal n may be calculated for example as the average sum of the squared time domain samples within the analysis frame identified by the index value f. This measure is computed for each channel of the source signal n.

The number of analysis frames to be marked as saturated may be computed according to equation (4) shown in the following.

$${clipSat}_{n} ( t ) = \frac{{\sum }_{f = startFrame}^{endFrame - 1} {\sum }_{ch = 0}^{{nCh}_{n} - 1} {isClipping}_{n} ( f , ch )}{{nCh}_{n}} \qquad ( 4 )$$

A frame is marked as saturated if it comprises signal samples that reach or are close to the maximum value of a dynamic range. A sample may be considered to be close to the maximum value of a dynamic range if its absolute value exceeds a predetermined threshold. As an example, the saturation status for the source signal n isClippingₙ may be evaluated such that if at least one of the samples within the analysis frame has a value greater than 2^{B-1}·0.0.95, where B is the bit depth of the source signal, the saturation statusisClippingₙ for the respective analysis frame is assigned to be 1 indicating a saturated analysis frame, otherwise it is assigned to be 0 indicating a non-saturated analysis frame. In an audio signal B is typically set to 16.

Equation (5), shown in the following, may be employed to calculate the number of analysis frames that have been marked as clicking, i.e. as analysis frames that are estimated to contain one or more short-term spikes.

$${clipClick}_{n} ( t ) = \frac{{\sum }_{f = startFrame}^{endFrame - 1} {\sum }_{ch = 0}^{{nCh}_{n} - 1} {isClicking}_{n} ( f , ch )}{{nCh}_{n}} \qquad ( 5 )$$

The clicking status for the source signal n isClickingₙ may be calculated using various methods known in the art, such as monitoring signal power level of sub-segments of analysis frames and comparing the signal power level of these segments to that of the neighboring sub-segments. If high signal power level is detected for a sub-segment but such is not detected for a neighboring sub-segment, e.g. if the signal power level of a sub-segment exceeds that of a temporally adjacent sub-segment by more than a predetermined threshold amount, the analysis frame is considered to comprise a sub-segment that is likely to be perceived as a clicking sound. Consequently, the clicking status isClickingₙ for the respective analysis frame is assigned to value 1, otherwise it is assigned to value 0.

Furthermore, equation(s) (6) may be employed to calculate a direction of arrival associated with the source signal n that may be used for ranking the source signals. Note that the equation(s) (6) result in a zero angle for a single-channel (monophonic) source signal, whereas a source signal with two or more channels may be provided with a non-zero angle.

$${cDirDiff}_{n} ( t ) = \{ \begin{matrix}90 ° - {cDir}_{n} ( t ) & {nCh}_{n} > 1 \\ 0 ° , & otherwise\end{matrix} \\ {cDir}_{n} ( t ) = ∠ ( {alfa\_r}_{n} ( t ) , {alfa\_i}_{n} ( t ) ) , \\ {alfa\_r}_{n} ( t ) = \frac{{\sum }_{ch = 0}^{{nCh}_{n} - 1} {cPower}_{n} ( t ) \cdot cos ( {φ}_{n , ch} )}{{\sum }_{ch = 0}^{{nCh}_{n} - 1} {cPower}_{n} ( t )} , \\ {alfa\_i}_{n} ( t ) = \frac{{\sum }_{ch = 0}^{{nCh}_{n} - 1} {cPower}_{n} ( t ) \cdot sin ( {φ}_{n , ch} )}{{\sum }_{ch = 0}^{{nCh}_{n} - 1} {cPower}_{n} ( t )} \qquad ( 6 )$$

where the angles φ_{n,ch} describe the microphone positions represented by source signal n in degrees with respect to center angle for the source signal n. In rendering point of view, these angles correspond to (assumed) loudspeaker positions. For example in a traditional stereo arrangement the microphone/loudspeaker positions correspond to angles correspond to 30 degrees and −30 degrees The equation(s) (6) serve to calculate the difference in the sound image direction with respect to the center angle for the given source signal. The center angle is in this example assumed to denote a direction of arrival directly in front of a capturing point, which conceptually maps to the magnetic north, i.e. zero degrees, if using compass plane as a reference. It may be advantageous to calculate the equation(s) (6) for stereo channel configuration in case the number of channels in the source signal n is more than two. In this case the source signal n may be dowmixed to two-channel representation using methods known in the art before applying the equation(s) (6).

The low-level signal measures described hereinbefore may then be used to rank the set of source signals. In this regard, the source signals that are not found to contain audible distortions may be ranked according to an exemplifying pseudo-code described in the following. The items, or lines, of the exemplifying pseudo code are numbered from 1 to 28, and these numbers shown on the left hand side hence do not form part of the pseudo code but rather serve as identifiers facilitating references to the pseudo code.

| | |
|---|---|
| 1 | $aThr = {10}^{0.1 \cdot D} , bThr = \frac{1}{aThr} , incThr = {10}^{0.1 \cdot INC} ,$ |
| | incThrI = 1/incThr |
| 2 | |
| 3 | clipRankIndices = sort vector rDataGood into descending |
| | order of importance, return corresponding indices of the |
| | ranked result into ‘clipRankIndices’ |
| 4 | |
| 5 | median_ clip = median_index(clipRankIndices) |
| 6 | rLevelIn = rLevels |
| 7 | rData_{median}_clip (t) = rLevelIn |
| 8 | |
| 9 | while(rLevelIn > 0) |
| 10 | { |
| 11 | isFound = 0; |
| 12 | |
| 13 | for(i = startIdx; i < nMedIdx; i++) |
| 14 | clipIdx = clipRankIndices(i) |
| 15 | If cEnergy_{clipIdx}(t) < aThr · cEnergy_{median}_clip(t) |
| 16 | If rData_{clipIdx}(t)== undefined |
| 18 | isFound = 1; rData_{clipIdx}(t) = rLevelIn |
| 19 | |
| 20 | for(i = nMedIdx + 1; i < N; i++) |
| 21 | If cEnergy_{clipIdx}(t) > bThr · cEnergy_{median}_clip(t) |
| 22 | If rData_{clipIdx}(t)== undefined |
| 23 | isFound = 1; rData_{clipIdx}(t) = rLevelIn |
| 24 | |
| 25 | if(isFound) exit while-loop; |
| 26 | |
| 27 | aThr *= incThr; bThr *= incThrI; rLevelIn -= 1; |
| 28 | } |

In the exemplifying pseudo code, function median_index( ) provides as its output the index of the vector element representing the median value of the vector rDataGood. Furthermore,

$$rDataGood = \{ \begin{matrix}{rData}_{n} ( t ) , & {isDistorted}_{n} ( t ) == False \\ skip , & otherwise\end{matrix} . \qquad ( 7 )$$

The exemplifying pseudo code assigns ranking values to source signals based on their energy level with respect to median energy level. First, on line 1, variables controlling the operation of a ranking loop of lines 9 to 28 are set to their initial values. The parameter D may be set for example to value 2 and the parameter INC may be set for example to value 1. Next, on line 3, the source signals with no distortion are sorted into descending order of importance based on their energy levels as calculated e.g. according to the equation (2). Sorting into the descending order of importance may comprise sorting into the descending order of calculated energy level. The median_index of this sorted vector, i.e. the index of the vector element indicative of the median value of the vector, is then determined on line 5. On line 7 the source signal exhibiting median energy level within all source signals is assigned the initial ranking value rLevels, where rLevels is the maximum ranking value that a source signal can have. The numerical value applied in context may be, for example rLevels=100. Next, in the ranking loop running from line 9 to line 28, the remaining source signals are ranked with respect to the source signal exhibiting median energy level within the source signals. If the energy of a source signal falls between the current values of the energy boundaries aThr, bThr, the source is assigned ranking value rLevelIn (lines 18 and 23), otherwise the values of the energy boundaries aThr, bThr are updated to increase the range of energies covered by the energy boundaries aThr, bThr and ranking level is decreased (line 27). The ranking loop is continued until at least one source signal exhibiting energy level falling between the current values of the energy boundaries aThr, bThr has been found or until all ranking levels have been processed. As a variation of the exemplifying pseudo code, the ranking loop may be continued until a ranking value has been assigned to all valid source signals, thereby essentially replacing the line 25 of the exemplifying pseudo code with a test whether all valid source signals have been assigned a ranking value as a condition for exiting the ranking loop.

The source signals with identified audible distortions may by ranked by using equation (8) shown in the following.

$${rData}_{n} ( t ) = \{ \begin{matrix}rLevel \cdot {satWeight}_{n} ( t ) , & \begin{matrix}{isDistorted}_{n} ( t ) == True or \\ {rData}_{n} ( t ) == undefined\end{matrix} \\ {rData}_{n} ( t ) , & otherwise\end{matrix} \\ {satWeight}_{n} ( t ) = 1.0 - {cSatWeight}_{n} ( t ) \cdot cSatWeightAll , \\ cSatWeightAll = \frac{1}{{\sum }_{n = 0}^{N - 1} \{ \begin{matrix}{cSatWeight}_{n} ( t ) , & {isDistorted}_{n} ( t ) == True \\ 0 , & otherwise\end{matrix}} \\ {cSatWeight}_{n} ( t ) = ( {clipSat}_{n} ( t ) + {clipClick}_{n} ( t ) ) \cdot {frameRes}_{n} \cdot iDur \cdot 100 \qquad ( 8 )$$

where frameResₙ describes the time resolution of the frame analysis for the source signal n, iDur=t_{end}−tₛₜₐᵣₜ describes the duration of the time segment of interest, rLevel=0.75·rLevelIn, and isDistortedₙ(t) is determined by using equation (9) shown in the following.

$${isDistorted}_{n} ( t ) = \{ \begin{matrix}False , & A < 3 \% and {clipClick}_{n} ( t ) < 2 \\ True , & otherwise\end{matrix} \\ A = {clipSat}_{n} ( t ) \cdot frameRes \cdot iDur \cdot 100 \qquad ( 9 )$$

In other words, in equation (9) a source signal is marked as distorted if at least 3% of the duration of the time segment of interest in the source signal n is known to contain saturated signal and at least 2 or more analysis frames within the time segment of interest in the source signal n contain clicking sub-segments. Furthermore, if any of the ranking values were modified, i.e. if the value of rDataₙ(t) was changed after completion of the equation(s) (8) for any of the source signals, rLevelIn is set to value defined by rLevel. The equation (8) assigns ranking value to each source signal based on its saturation and clicking contribution relative to the combined saturation and clicking contribution from all distorted source signals within the time segment of interest.

Once the initial ranking of all source signals has been completed, source signal having no spatial image or having only negligible spatial image may be scaled down in the ranking scale according to equation (10) to provide preference to source signals exhibiting a meaningful spatial audio image. Such source signals of limited or no spatial image may comprise single-channel (monophonic) audio signals and/or two-channel (stereophonic) or multi-channel signals with the spatial image representing audio sources essentially in the middle of the audio image, hence perceptually positioned essentially directly in front of the listener.

$${rData}_{n} ( t ) = \{ \begin{matrix}max ( 0 , {rData}_{n} ( t ) - rLevels \cdot 0.8 ) , & {cDirDiff}_{n} ( t ) < 0.1 ° \\ {rData}_{n} ( t ) , & otherwise\end{matrix} \qquad ( 10 )$$

Along similar lines, two-channel or multi-channel source signals exhibiting audio image with audio sources close to the leftmost boundary of the audio image or close to the rightmost boundary of the audio image may be scaled down in the ranking scale according to equation (11).

$${rData}_{n} ( t ) = \{ \begin{matrix}\frac{{rData}_{n} ( t ) + ( rLevelIn - 1 ) \cdot {dirWeight}_{n} ( t )}{2} , & {cDirDiff}_{n} ( t ) > 10 ° \\ {rData}_{n} ( t ) , & otherwise\end{matrix} \\ {dirWeight}_{n} ( t ) = 1.0 - {cDirDiff}_{n} ( t ) \cdot cDirDiffAll \\ cDirDiffAll = \frac{1}{{\sum }_{n = 0}^{N - 1} \{ \begin{matrix}{cDirDiff}_{n} ( t ) , & {cDirDiff}_{n} ( t ) > 10 ° \\ 0 , & otherwise\end{matrix}} \qquad ( 11 )$$

In case the equation(s) (11) results in modification of a ranking value rDataₙ(t) for the source signal n, the modification involves setting rLevelIn is set to rLevelIn−1. Analogous to the equation(s) (8), ranking of a source signal is weighted based on its contribution in relation to the combined contribution of source signals considered the equation(s) (11) to the step. Thus, the processing according to the equation(s) (11) gives preference to source signals which are more balanced in the stereo image. In other words, the more biased the stereo image is towards the left or the right channel, the more weight it gets in scaling down the ranking value. Consequently, the values of the parameter vector rDataₙ(t) now represent the ranking values for the N source signals over the time period of interest. Basically, a higher ranking value implies better quality of a sound source. Thus, if applied to the plurality of audio reduced audio signals, a higher ranking value indicates a reduced audio signal representing a captured audio signal better suited for determination of the audio composition signal.

A second exemplifying ranking approach provides an iterative ranking process, wherein in each iteration round two or more source signals are assigned a ranking value using an analysis approach associated with the respective iteration round, and wherein in each iteration round one or more source signals having ranking values indicating lowest quality associated therewith are excluded from consideration in subsequent iteration rounds. Such an iterative ranking process may be also referred to as pruning based ranking process owing to the fact that for each processing round the remaining set of source signals is pruned to be smaller than in the current processing round.

The second exemplifying ranking approach advantageously applies two or more different analysis approaches in such a way that the computational complexity of an analysis approach employed at a given iteration round is lower than or equal to that of the analysis approach employed at a subsequent iteration round. The computational complexity as referred to herein may be e.g. an average computational complexity of an analysis approach, a maximum computational complexity of an analysis approach or a value determined as a combination of the two. This contributes to employing less complex analysis approaches for the early iteration rounds where the number of considered source signals is higher while more complex analysis approaches are employed in later iteration rounds where the number of considered source signals is smaller, thereby contributing to keeping the overall complexity of the ranking process at a reasonable level. This effect may in some scenarios amount to significant savings in computational complexity due to hundreds or even thousands of source signals being considered in the first iteration round or in the first few iteration rounds.

The first exemplifying ranking approach described in detail hereinbefore may be used as the analysis approach in the first iteration round of the second exemplifying ranking approach. Proceeding based on this exemplifying selection of the analysis approach for the initial iteration round of the second exemplifying ranking approach, after completion of ranking according to the first exemplifying ranking approach, the next step is to exclude the source signals with lowest rank from further processing in the subsequent iteration rounds. The exclusion may comprise discarding or excluding the source signals with ranking values that are below the median ranking value by a certain predetermined amount and/or the source signals with ranking values that are below the mean ranking value (computed e.g. as an arithmetic mean) by a certain predetermined amount. Alternatively, the exclusion may comprise selecting M source signals exhibiting the highest ranking values among the N source signals, where M<N for further ranking in subsequent iteration rounds and, consequently, excluding the other source signals from the subsequent iteration rounds.

The exclusion may be carried out for each time segment of interest separately or the source signals may be excluded based on their ranking value at the timeline level. The exclusion at the timeline level here refers to an approach that involves considering a number of temporally distinct time segments of the source signal or, in particular, considering the source signal in full. If exclusion is done at the timeline level the ranking value for the source signal n may be set according to equation (12) shown in the following.

$${sourceRank}_{n} = {\sum }_{t = 0}^{{T}_{n}} {tWeight}_{n} \cdot {rankData}_{n} ( t ) . rValue , \\ {tWeight}_{n} = \frac{{rankData}_{n} ( t ) . segEnd - {rankData}_{n} ( t ) . segStart}{{duration}_{n}} \qquad ( 12 )$$

where Tₙ is the number of time segments for the source signal n and

$${rankData}_{n} ( t ) . \{ \begin{matrix}rValue = {rData}_{n} ( t ) \\ segStart = {t}_{start} \\ segEnd = {t}_{end}\end{matrix} \qquad ( 13 )$$

In other terms, the ranking value for the source signal n may be the accumulated and weighted ranking value from all overlapping segments of the source signal n, where the weighting for a given segment is determined as the ratio between the duration of the given segment and the duration of the source signal n. It should be also noted that there may be time segments for which the source signal n is not available and that equation (13) is applicable only when the source signal n is available for a given time segment specified by the start point tₛₜₐᵣₜ and the end point t_{end}. There may be segments where only limited set of the source signals are present due to non-overlapping condition being not valid for the remaining source signals.

In general, the exclusion may also be a combination of the above, such that at some iteration rounds may involve excluding source signals at time segment level while some iteration rounds may involve excluding source signals at the timeline level.

The second iteration round may involve performing further ranking based on frequency analysis of the source signals. In such an analysis signal measure values would be calculated similarly to the equations (2)-(6) but the actual analysis values would be based on frequency domain data. As an example, the frequency analysis may comprise determining a measure descriptive of the amount of high frequency content of a source signal with respect to low frequency content of the same source signal. Consequently, the higher the audio signal bandwidth of a source signal would be the more weight it would have in the overall ranking or vice versa (as high audio bandwidth typically implies also higher perceptual clarity). Another example of a measure derivable in the frequency analysis is a spectral response, where certain spectral bands of a source signal are monitored with respect to other spectral bands of the source signal. One specific example of this comprises monitoring signal content at a low frequency spectral band with respect to neighboring spectral bands. Such an approach may be useable to either emphasize or de-emphasize source signals that have strong bass-effect or vice versa in a manner analogous to that employed in the first exemplifying ranking approach. As the second iteration round operates in frequency domain, it typically involves higher computational complexity as the first exemplifying ranking approach employed in the first iteration round operating on time-domain signals.

The third and subsequent iteration rounds may employ analysis approach that is based on joint processing of the selected source signals. Such joint processing may be based for example on joint ranking of source signals in spectral domain, e.g. according a process described in WO 2012/098425, which is hereby incorporated by reference. As such an analysis approach may represent rather significant computational complexity, it may be advantageous to limit the number of source signals to a predetermined maximum number K, where the value of K may be set, for example, to a value in the range from 5 to 10.

At each iteration round the ranking values of the included source signals are added with an offset value that is equal to the highest ranking value from the source signals that were excluded from the current iteration round. This serves to keep the overall ranking of source signals in correct order. The final ranking for the source signals in the timeline level may then be determined according to the equation (12), as described hereinbefore.

The operations, procedures and/or functions assigned to the structural units of the client 110a, 110b, i.e. to the audio capture portion 112, to the audio processing portion 114 and to the interface portion 116, may be divided between these portions in a different manner. Moreover, the client 110a, 110b may comprise further portions or units that may be configured to perform some of the operations, procedures and/or functions assigned to the above-mentioned portions.

On the other hand, the operations, procedures and/or functions assigned to the above-mentioned portions of the client 110a, 110b may be assigned to a single portion or to a single processing unit within the client 110a, 110b. In particular, the client 110a, 110b may be embodied, for example, in an apparatus comprising means for capturing an audio signal, means for extracting audio signal components representing a first predetermined frequency band from the audio signal to form a reduced audio signal, and means for providing the reduced audio signal for a second apparatus for further processing, and means for providing, in response to a request from the second apparatus, a complementary audio signal representing a second predetermined frequency band of the audio signal, wherein the second predetermined frequency band comprises frequency components of the respective audio signal excluded from the first predetermined frequency band.

The operations, procedures and/or functions assigned to the structural units of the server 130, i.e. the reception portion 132, the ranking portion 134, the selection portion 136 and the signal composition portion 138, may be divided between these portions in a different manner. Moreover, the server 130 may comprise further portions or units that may be configured to perform some of the operations, procedures and/or functions assigned to the above-mentioned portions.

On the other hand, the operations, procedures and/or functions assigned to the above-mentioned portions of the server 130 may be assigned to a single portion or to a single processing unit within the server 130. In particular, the server 130 may be embodied, for example, in an apparatus comprising means for obtaining a plurality of reduced audio signals, each representing a first predetermined frequency band of a respective audio signal, means for determining, for each of the plurality of audio signals for a signal segment corresponding to a given period of time, a ranking value indicative of the quality of the respective audio signal on basis of the respective reduced audio signal, means for selecting an audio signal of the plurality of audio signals for determination of a segment of an audio composition signal on basis of the determined ranking values, and means for determine the segment of the audio composition signal on basis of the selected audio signal.

The operations, procedures and/or functions described hereinbefore in context of the client 110a, 110b may also be embodied as steps of a method implementing the corresponding operation, procedure and/or function.

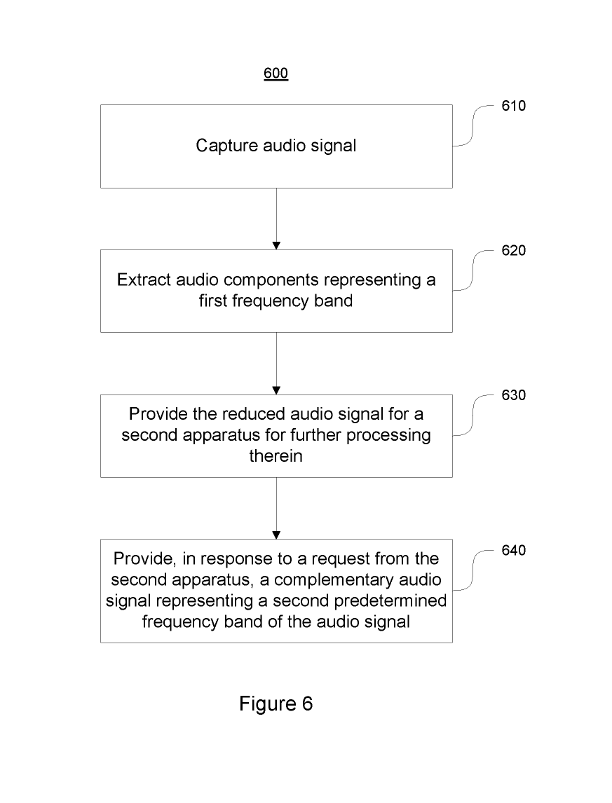

As an example in this regard, FIG. 6 illustrates a method 600. The method 600 comprises capturing an audio signal, as indicated in block 610 and as described in more detail hereinbefore in context of the audio capture portion 112. The method 600 further comprises extracting audio signal components representing a first predetermined frequency band from the audio signal to form a reduced audio signal, as indicated in block 620 and as described in more detail hereinbefore in context of the audio processing portion 114.

The method 600 further comprises providing the reduced audio signal for a second apparatus for further processing therein, as indicated in block 630 and as described in more detail hereinbefore in context of the interface portion 116. The method 600 further comprises providing, in response to a request from the second apparatus, a complementary audio signal representing a second predetermined frequency band of the audio signal, wherein the second predetermined frequency band comprises frequency components of the respective audio signal excluded from the first predetermined frequency band.

The operations, procedures and/or functions described hereinbefore in context of the server 130 may also be embodied as steps of a method implementing the corresponding operation, procedure and/or function.

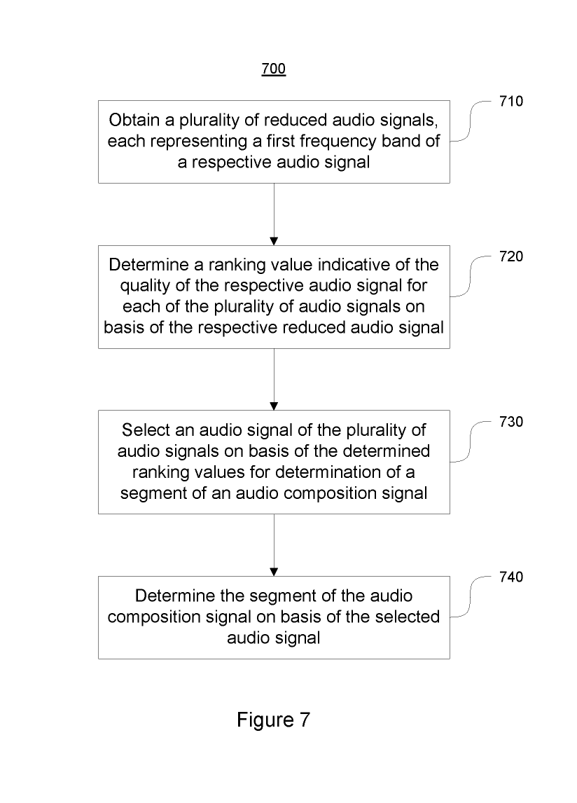

As an example in this regard, FIG. 7 illustrates a method 700 for determining an audio composition signal. The method 700 comprises obtaining a plurality of reduced audio signals, each representing a first predetermined frequency band of a respective audio signal, as indicated in block 710 and as described in more detail in context of the audio capture portion 112 and/the reception portion 132. The first predetermined frequency band may comprise, for example, lowest frequency components up to a predetermined threshold frequency or, as another example, the first predetermined frequency band may comprise frequency components from a predetermined lower threshold frequency to a predetermined upper threshold frequency, as described hereinbefore in context of the audio capture portion 112 and the reception portion 132. Obtaining the plurality of reduced audio signals may comprise, for example, receiving the plurality of reduced audio signals consisting of audio signal components representing the first predetermined frequency band from a plurality of capturing apparatuses, as described hereinbefore in context of the reception portion 132. As another example, obtaining said plurality of reduced audio signals may comprise extracting audio signal components representing the first predetermined frequency band from the respective audio signals, as described hereinbefore in context of the reception portion 132.

The method 700 further comprises determining, for each of the plurality of audio signals for a signal segment corresponding to a given period of time, a ranking value indicative of the quality of the respective audio signal on basis of the respective reduced audio signal, as indicated in block 720 and as described in more detail hereinbefore in context of the ranking portion 134. A ranking value may be indicative of an extent of perceivable distortions, such as an extent of sub-segments of the reduced audio signal comprising saturated signal and/or an extent of sub-segments of the reduced audio signal exhibiting signal power level exceeding that of a temporally adjacent sub-segment by more than a predetermined amount, identified in a reduced audio signal, as described in more detail hereinbefore in context of the ranking portion 134.

The method 700 further comprises selecting an audio signal of the plurality of audio signals for determination of a segment of an audio composition signal on basis of the determined ranking values, as indicated in block 730 and as described in detail hereinbefore in context of the selection portion 136. The selection may comprise, for example, selecting the audio signal of the plurality of audio signals having the ranking value indicating highest quality determined therefor, as described in more detail hereinbefore in context of the selection portion 136.

The method 700 further comprises determining the segment of the audio composition signal on basis of the selected audio signal, as indicated in block 740 and as described in more detail hereinbefore in context of the signal composition portion 138. Determining the segment of the audio composition signal may comprise obtaining a complementary audio signal representing a second predetermined frequency band of the selected audio signal and determining the segment of the audio composition signal as a combination of the complementary audio signal and the respective reduced audio signal, as described hereinbefore in context of the signal composition portion, wherein the second predetermined frequency band may comprise frequency components of the respective audio signal excluded from the first predetermined frequency band, as further described hereinbefore in context of the signal composition portion 138.

FIG. 8 schematically illustrates an exemplifying apparatus 800 that may be employed to embody to client 110a, 110b and/or the server 130. The apparatus 800 comprises a processor 810, a memory 820 and a communication interface 830, such as a network card or a network adapter enabling wireless or wireline communication with another apparatus. The processor 810 is configured to read from and write to the memory 820. The apparatus 800 may further comprise a user interface 840 for providing data, commands and/or other input to the processor 810 and/or for receiving data or other output from the processor 810, the user interface 840 comprising for example one or more of a display, a keyboard or keys, a mouse or a respective pointing device, a touchscreen, etc. The apparatus 800 may comprise further components not illustrated in the example of FIG. 8.

Although the processor 810 is presented in the example of FIG. 8 as a single component, the processor 810 may be implemented as one or more separate components. Although the memory 820 in the example of FIG. 8 is illustrated as a single component, the memory 820 may be implemented as one or more separate components, some or all of which may be integrated/removable and/or may provide permanent/semi-permanent/dynamic/cached storage.

The apparatus 800 may be embodied for example as a mobile phone, a camera, a video camera, a music player, a gaming device, a laptop computer, a desktop computer, a personal digital assistant (PDA), an internet tablet, a server device, a mainframe computer, etc.

The memory 820 may store a computer program 850 comprising computer-executable instructions that control the operation of the apparatus 800 when loaded into the processor 810. As an example, the computer program 850 may include one or more sequences of one or more instructions. The computer program 850 may be provided as a computer program code. The processor 810 is able to load and execute the computer program 850 by reading the one or more sequences of one or more instructions included therein from the memory 820. The one or more sequences of one or more instructions may be configured to, when executed by one or more processors, cause an apparatus, for example the apparatus 800, to implement the operations, procedures and/or functions described hereinbefore in context of the client 110a, 110b and/or those described hereinbefore in context of the server 130.

Hence, the apparatus 800 may comprise at least one processor 810 and at least one memory 820 including computer program code for one or more programs, the at least one memory 820 and the computer program code configured to, with the at least one processor 810, cause the apparatus 800 to perform the operations, procedures and/or functions described hereinbefore in context of the client 110a, 110b and/or those described hereinbefore in context of the server 130.

The computer program 850 may be provided at the apparatus 800 via any suitable delivery mechanism. As an example, the delivery mechanism may comprise at least one computer readable non-transitory medium having program code stored thereon, the program code which when executed by an apparatus cause the apparatus at least implement processing to carry out the operations, procedures and/or functions described hereinbefore in context of the client 110a, 110b and/or those described hereinbefore in context of the server 130. The delivery mechanism may be for example a computer readable storage medium, a computer program product, a memory device a record medium such as a CD-ROM or DVD, an article of manufacture that tangibly embodies the computer program 850. As a further example, the delivery mechanism may be a signal configured to reliably transfer the computer program 850.

The computer program 850 may be adapted to implement any of the operations, procedures and/or functions described hereinbefore in context of the client 110a, 110b, e.g. those described in context of the audio capture portion 112, those described in context of the audio processing portion 114 and/or those described in context of the interface portion 116. Alternatively or additionally, the computer program 850 may be adapted to implement any of the operations, procedures and/or functions described hereinbefore in context of the server 130, e.g. those described in context of the reception portion 132, those described in context of the ranking portion 134, those described in context of the selection portion 136 and/or those described in context of the signal composition portion 138.

Reference to a processor should not be understood to encompass only programmable processors, but also dedicated circuits such as field-programmable gate arrays (FPGA), application specific circuits (ASIC), signal processors, etc. Features described in the preceding description may be used in combinations other than the combinations explicitly described. Although functions have been described with reference to certain features, those functions may be performable by other features whether described or not. Although features have been described with reference to certain embodiments, those features may also be present in other embodiments whether described or not.

1-92. (canceled)

93. An apparatus comprising at least one processor and at least one memory including computer program code for one or more programs, the at least one memory and the computer program code configured to, with the at least one processor, cause the apparatus to perform at least the following:
obtain a plurality of reduced audio signals, each representing a first predetermined frequency band of a respective audio signal,
determine, for each of the plurality of audio signals for a signal segment corresponding to a given period of time, a ranking value indicative of the quality of the respective audio signal on basis of the respective reduced audio signal,
select an audio signal of the plurality of audio signals for determination of a segment of an audio composition signal on basis of the determined ranking values, and
determine the segment of the audio composition signal on basis of the selected audio signal.

94. An apparatus according to claim 93, wherein selecting the audio signal comprises selecting the audio signal of the plurality of audio signals having the ranking value indicating highest quality determined therefor.

95. An apparatus according to claim 93, wherein the first predetermined frequency band comprises lowest frequency components up to a predetermined threshold frequency.

96. An apparatus according to claim 93, wherein the first predetermined frequency band comprises frequency components from a predetermined lower threshold frequency to a predetermined upper threshold frequency.

97. An apparatus according to claim 93, wherein obtaining said plurality of reduced audio signals comprises receiving the plurality of reduced audio signals consisting of audio signal components representing the first predetermined frequency band from a plurality of capturing apparatuses.

98. An apparatus according to claim 93, wherein obtaining said plurality of reduced audio signals comprises extracting audio signal components representing the first predetermined frequency band from the respective audio signals.

99. An apparatus according to claim 93, wherein determining the segment of the audio composition signal comprises obtaining a complementary audio signal representing a second predetermined frequency band of the selected audio signal and determining the segment of the audio composition signal as a combination of the complementary audio signal and the respective reduced audio signal.

100. An apparatus according to claim 99, wherein the second predetermined frequency band comprises frequency components of the respective audio signal excluded from the first predetermined frequency band.

101. An apparatus according to claim 93, wherein a ranking value is indicative of an extent of perceivable distortions identified in a reduced audio signal.

102. An apparatus according to claim 101, wherein said perceivable distortions comprise sub-segments of the reduced audio signal comprising least one of saturated signal and sub-segments of the reduced audio signal exhibiting signal power level exceeding that of a temporally adjacent sub-segment by more than a predetermined amount.

103. An apparatus according to claim 93, wherein determination of the ranking value comprises analyzing the reduced audio signal in order to identify perceivable distortions in a reduced audio signal such that a high number of perceivable distortions implies a ranking value indicative of low quality whereas a low number of perceivable distortions implies a ranking value indicative of high quality.

104. An apparatus according to claim 93, wherein determination of the ranking value comprises applying an iterative ranking process such that in each iteration round one or more of the plurality of audio signals having ranking values indicating lowest quality associated therewith are excluded from consideration in subsequent iteration rounds.

105. An apparatus according to claim 104, wherein the quality measure used for ranking at a given iteration round exhibits computational complexity smaller than or equal to that of the quality measure used for ranking in a subsequent iteration round.

106. An apparatus according to claim 104, wherein one or more first iteration rounds employ a quality measure derived in time-domain, one or more subsequent iteration rounds employ a quality measure derived in frequency-domain, and one or more still subsequent iteration rounds employ a quality measure derived by joint processing of a number of reduced audio signals.

107. A method comprising
obtaining a plurality of reduced audio signals, each representing a first predetermined frequency band of a respective audio signal,
determining, for each of the plurality of audio signals for a signal segment corresponding to a given period of time, a ranking value indicative of the quality of the respective audio signal on basis of the respective reduced audio signal,
selecting an audio signal of the plurality of audio signals for determination of a segment of an audio composition signal on basis of the determined ranking values, and
determining the segment of the audio composition signal on basis of the selected audio signal.

108. A method according to claim 107, wherein selecting the audio signal comprises selecting the audio signal of the plurality of audio signals having the ranking value indicating highest quality determined therefor.

109. A method according to claim 107, wherein the first predetermined frequency band comprises lowest frequency components up to a predetermined threshold frequency.

110. A method according to claim 107, wherein the first predetermined frequency band comprises frequency components from a predetermined lower threshold frequency to a predetermined upper threshold frequency.

111. A method according to claim 107, wherein obtaining said plurality of reduced audio signals comprises receiving the plurality of reduced audio signals consisting of audio signal components representing the first predetermined frequency band from a plurality of capturing apparatuses.

112. A computer program product comprising at least one computer readable non-transitory medium having program code stored thereon, the program which when executed by an apparatus cause the apparatus at least to
obtain a plurality of reduced audio signals, each representing a first predetermined frequency band of a respective audio signal,
determine, for each of the plurality of audio signals for a signal segment corresponding to a given period of time, a ranking value indicative of the quality of the respective audio signal on basis of the respective reduced audio signal,
select an audio signal of the plurality of audio signals for determination of a segment of an audio composition signal on basis of the determined ranking values, and
determine the segment of the audio composition signal on basis of the selected audio signal.
